(19) United States
(12) Patent Application Publication
(10) Pub. No.: US 2021/0065319 A1
(43) Pub. Date: Mar. 4, 2021

(54) PROPERTY RESOURCE RIGHTS MANAGEMENT SYSTEMS AND METHODS

(71) Applicant: ILITY.COM LLC, New York, NY (US)

(72) Inventors: Marcus E. Moufarrige, New York, NY (US); Mayank Mishra, Livingston, NJ (US)

(21) Appl. No.: 17/005,669

(22) Filed: Aug. 28, 2020

Related U.S. Application Data
(60) Provisional application No. 62/893,541, filed on Aug. 29, 2019.

(51) Int. Cl. G06Q 50/16; G06Q 40/04

(52) U.S. Cl. CPC G06Q 50/163; G06Q 40/04

(57) ABSTRACT

Methods, systems and computer products for property resource rights management are provided. A model is trained based on property resource usage data according to a machine learning algorithm, thereby generating a trained model. A rights template is generated using the trained model. The rights template is stored in a rights template store. The rights template can contain one or more attributes associated with the type of property resource, one or more rules associated with the type of property resource, one or more workflows associated with the type of property resource, and at least one linking between two or more rights templates. The rights templates are used to provision property resources.

### CROSS REFERENCE TO RELATED APPLICATIONS

This application claims priority to, and the benefit of, U.S. Provisional Patent Application Ser. No. 62/893,541, filed Aug. 29, 2020, which is hereby incorporated by reference in its entirety.

### TECHNICAL FIELD

Example aspects described herein relate generally to resource management, and more particularly to monitoring, identifying, selecting and managing property-related resources.

### BACKGROUND

In the context of property-related real asset management, building owner, landlord, occupant and building operator time is wasted, and the needs and comfort of the occupants are sacrificed. Existing property management systems are rudimentary and offer little in the way of usability, flexibility and amenity management.

Generally, a property management system (PMS) operates as a centralized computer system that is used to organize, schedule and perform property-related functions such as booking rooms, check-in/out, telephone integrations, event planning, food and beverage costing, reporting of key performance indicators, and security. A typical PMS, however, is merely a conduit through which disparate subsystems are accessed. The property-related subsystems are connected to the PMS independently and designed to perform specific tasks and interface with building owners, landlords, occupants (e.g., tenants) and building operators through the PMS. For example, one such subsystem might provide portals that allow owners and landlords to communicate with occupants. Another subsystem might provide property operations management, accounting and analytics. And yet another subsystem might provide security and building environment controls. Access to these systems is typically limited to only a few authorized personnel.

One reason property management systems are generally found to be inflexible is that a typical PMS simply does not have the ability to intelligently ingest and process real asset information nor provision services holistically and dynamically. The consequence is the highly inefficient use of computing and communication resources, and ultimately the use of manual workflows to provide a limited number of services and amenities.

There exists, therefore, a need for a centralized platform that enables the various real-asset related resources to intelligently and automatically communicate, and enables the provisioning of deeper capabilities while removing service delivery complexity.

### BRIEF SUMMARY

Aspects of the present invention provide systems, methods, and computer program products that provide resource-saving mechanisms for the management of real asset resources, e.g., for building owners, landlords and occupants (e.g., tenants), as well as building operators.

In an example embodiment, aspects of properties are profiled into different types of property resource digital objects by a computer-implemented rights management system. In turn, the rights management system uses the different types of property resource digital objects to monitor, select, retrieve, identify, and/or manage the possession, control, exclusion, enjoyment and disposition of the aspects of the property resources.

In an example embodiment, a computer-facilitated method for optimizing management of property resource rights is provided. The method includes digitizing a property resource having a type and at least one attribute, thereby generating a property resource inventory object; and generating a property resource rights object for the property resource based on the property resource inventory object and a rights template.

In some embodiments, the method includes generating a rights template based on a mapping one or more labels associated with the type of property resource, one or more rules associated with the type of property resource, one or more workflows associated with the type of property resource, and one or more linkings between two or more rights templates. The property resource can be a real asset resource, a service or a transaction.

In some embodiments, the method includes training a model based on property resource usage data according to a machine learning algorithm, thereby generating a trained model; generating a rights template based using the trained model; and storing, in a rights template store, the rights template. The rights template can contain one or more attributes associated with the type of property resource, one or more rules associated with the type of property resource, one or more workflows associated with the type of property resource, and at least one linking between two or more rights templates

In some embodiments, the method includes generating a property resource stock object by applying the rights template to the property resource inventory object. The property resource stock object can contains one or more labels associated with type of property resource, one or more rules associated with type of property resource, one or more workflows associated with type of property resource, at least one linking between two or more rights templates, and one or more attributes from the property resource inventory object.

In another example embodiment, there is provided a non-transitory computer-readable medium having stored thereon one or more sequences of instructions for causing one or more processors to perform the methods according to any one of the methods described herein.

In yet another embodiment, there is provided a system for optimization of property resource rights management, comprising one or more processors and one or more storage devices storing instructions that are operable, when executed by the one or more processors, to cause the one or more processors to perform any one of the methods described herein.

### BRIEF DESCRIPTION OF THE DRAWINGS

The features and advantages of the example embodiments of the invention presented herein will become more apparent from the detailed description set forth below when taken in conjunction with the following drawings.

FIG. 1 is an architecture of a property resource rights management system in accordance with an example embodiment of the present invention.

FIG. 2 depicts architectural diagram illustrating flows according to an example aspect of the present invention.

FIG. 3 is a process flow in accordance with an example embodiment of the present invention.

FIG. 4 illustrates an example rights template in accordance with an example embodiment of the present invention.

FIG. 5 illustrate an example property resource stock object according to an example embodiment of the present invention.

### DETAILED DESCRIPTION

The example embodiments of the invention presented herein are directed to methods, systems and computer program products for providing resource management, which are now described herein in terms of an example property-related resource management system. This description is not intended to limit the application of the example embodiments presented herein to only property-related resources. In fact, after reading the following description, it will be apparent to one skilled in the relevant art(s) how to implement the following example embodiments in alternative embodiments, for example, involving any type of real asset, such as precious metals, commodities, as well as various types of property (e.g., real estate, land, equipment, and natural resources), services, or transactions.

A property resource is a real asset resource, a service or a transaction. One aspect of the present invention facilitates the procurement of AST (real asset resources, services and transactions).

A “real asset resource” as used herein is a tangible item, article or good owned by a person or company. In some embodiments, a set of real asset resources are finite (i.e., the real asset resources are not unlimited). Examples of a real asset resource in the context of property include a long term real estate space, a short term real estate space, a parking space, units of furniture, telephone numbers, power tool(s), work(s) of art, and the like. For simplicity a “real asset resource” is interchangeably referred to herein as a “real asset”.

A “service” as used herein means the act of serving, such as by providing useful labor that does not produce a tangible commodity. There can be many types of services. Examples of a service include access control, billing, a membership, a meeting room booking, access to a particular space, authentication, providing computing services (e.g., software access), mail handling, reception, communications (e.g., LAN/WAN, phone, WiFi, etc.). In some embodiments, a service is finite (i.e., the service is not unlimited).

A “transaction” as used herein means an instance of buying or selling something. Example transactions include procurement of a real asset resource or service such as a unit of furniture, office supplies, snacks, fit-out, a tenant incentive, loyalty points, partner products, and providing a cup of coffee. A “fit-out” is an act of providing the necessary equipment and/or decorations for a real estate space.

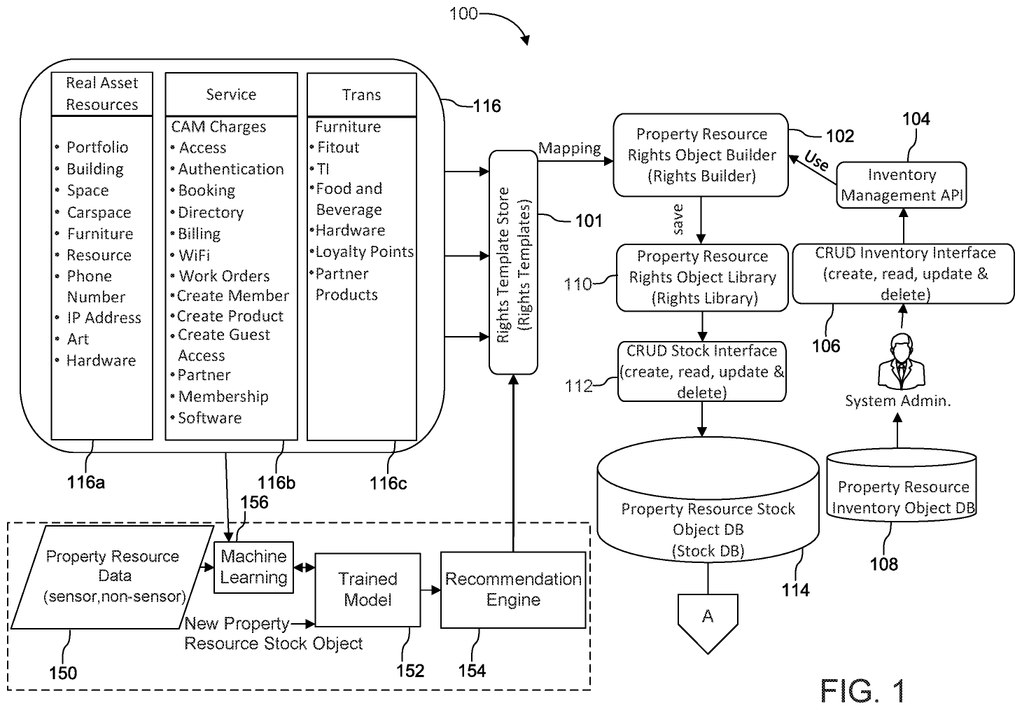

FIG. 1 is an architecture of a property resource rights management system 100 in accordance with an example embodiment of the present invention. Initially, property resources (e.g., real assets, services and transactions) are identified and digitized into digital objects referred to as property resource inventory objects (also referred to simply as “inventory”) in a property resource inventory object database 108. Property resource inventory objects store digitized property resources (e.g., real asset resources, services, and transactions) according to their respective attributes in the form of fields and data labels describing the particular property resource (e.g., a desk identified as having a serial number, length, height, width, footprint area, and style; a communications resource such as WiFi, etc.). In some embodiments, digitization of a property resource into a property resource digital object involves collecting and aggregating all the data that characterizes the property resource during the different phases of its life cycle in order to make it available within a collaborative property resource rights management system 100.

A “rule” as used herein is a set of instructions (e.g., one or more instructions) that is performed. In some cases a rule is performed in a case of any matching event occurring within a corresponding workflow. A “workflow” is used to automate processes. A workflow rule (referred to herein simply as a rule) can be a container for a set of workflow instructions. These instructions can be in the form of a conditional statement such as in an if/then/else conditional statement or in the form of a business object model (BOM). A “business object model” as used herein is an object model describing the realization of business use cases. It serves as an abstraction of how business subsystems and business entities need to be related and how they need to collaborate in order to perform a business function.

In an example implementation, sensors are located throughout a property. Data from the sensors are digitally converted, stored and processed. In some embodiments, the property resources are identified, monitored by the sensors and the data from the sensors is digitized in realtime. In some embodiments, property resource data other than sensor data may be collected and processed. For example property resource data can include the number of floors (e.g., obtained from a stacking plan). A stacking plan is a visual representation of a building showing a breakdown of space occupied by tenants on each individual floor. The breakdown may extend to include other details of the tenant such as their company name, occupied square footage, lease expiration date or rental rate. Property resource data can also include more details about the tenant, such as details about the business and operations of the tenant.

Property resource data 150 from the sensors and non-sensor data is received and used in coordination with potential property resources to provide services and amenities as described more fully herein. For example, one such property resource may relate to a space (e.g., an area or room such as a bathroom, a lobby, an elevator). One or more sensors can be used to detect occupancy of the space. Non-sensor data can include, for example, a number of employees associated with the business of a tenant on the property. In an example implementation, an elevator occupancy can be detected by a sensor in realtime. If the tenant (or an occupant of the tenant) indicates via an interface of the property resource rights management system 100 that they intend to leave the property, the interface can output a notification as to the elevator's occupancy status and recommend an appropriate time to leave (perhaps in 10 minutes).

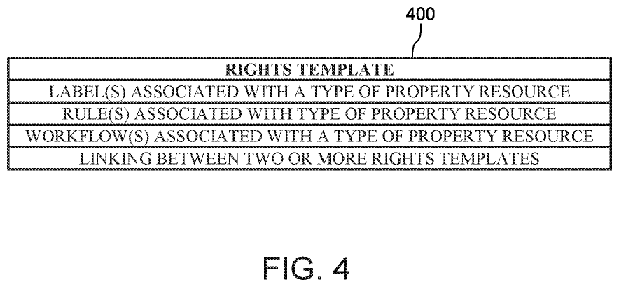

In some embodiments, so-called “rights templates” are generated. FIG. 4 illustrates an example rights template 400 in accordance with an example embodiment of the present invention. A rights template 400 stores data associated with a type of property resource including, for example, one or more attributes associated with the type of property resource, one or more rules associated with the type of property resource, one or more workflows associated with the type of property resource, and any linking between two or more rights templates 400. In other words, a rights template 400 includes attributes about a type of property resource and rules (i.e., rights) associated with the type of property resource. The rights templates 400 are stored in a rights template store 101. In an example embodiment, a rights template 400 is generated according to a data-interchange format (e.g., JSON). The rights templates 400 can be shared with other components and used to generate real estate leads, examining past and present forecasting data, and coordinate property management.

In an example embodiment, rights templates 400 are generated using machine learning. In this example embodiment a machine learning component 156 trains a model using a machine learning algorithm according to the (e.g., historical) usage of a plurality of property resources (e.g., real assets) for the purpose of data mining. A model that is trained is depicted in FIG. 1 as trained model 152. Generally, the model is trained through learning (determining) good values for all the weights and a bias from labeled examples. In one example implementation, machine learning component 156 builds trained model 152 by examining many examples of digitized property resources to find a model that minimizes loss through a process referred to as empirical risk minimization.

The usage data is mapped to the trained model 152 according to the machine learning algorithm executed by machine learning component 156. In an example implementation, the usage data of property resources (e.g., real assets) are mapped to a vector space. In turn, a distance between the attributes of the property resource (e.g., real asset) usage data is measured to obtain the closest attributes and hence relationships among property resources. For example, if a desired working area is a desk for an executive versus for a workstation for a technician, the trained model 152 will have been trained to recognize an appropriate type of chair for the executive and technician.

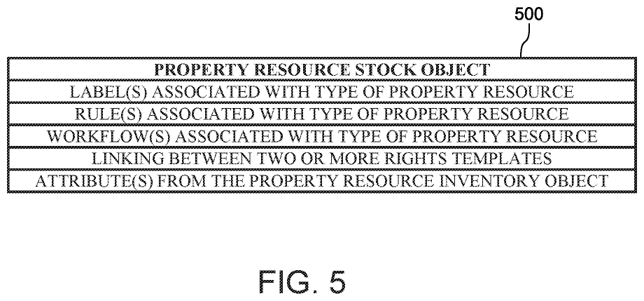

FIG. 5 illustrate an example property resource stock object 500 according to an example embodiment of the present invention. A “property resource stock object” is the result of the application of a rights template 400 to a property resource inventory object. As shown in FIG. 5, a property resource stock object 500 can include one or more labels associated with a type of property resource, one or more rules associated with the type of property resource, one or more workflows associated with type of property resource, any linking between two or more rights templates 400, and one or more attributes from the property resource inventory object. An example rule includes permission to use a property resource and example labels can include pricing, costing, term, and duration templating. TABLE 1 is an illustration of various property resource stock object 500 examples:

TABLE 1
MEETING ROOM (real asset)

INVENTORY

Name: Coolest Meeting Room
Property: One World Trade Center (285 Fulton St,
New York, NY 10007)
Area (sqft): 50,000
Booking start time: 9:00 AM
Booking end time: 5:00 PM
Booking days: Monday, Tuesday, Wednesday, Thursday,
Friday
Description: Wow, what an amazing meeting room
Calendar: Connected via Microsoft Exchange
Max capacity: 10
Term:
Price:

STOCK

```
PERMISSION
  The right to book a meeting room [Roles]
RULES
  IF booking is submitted, check billing
  IF booking is submitted, check access
  IF checks fail, send notification to tenant
  IF checks fail, send notification to account manager
  IF checks pass, confirm booking
  IF booking is confirmed, send calendar details
  IF booking is confirmed, send confirmation email
  IF external guest is invited, activate guest workflow
  IF internal guest is invited, send invite
  IF booking is completed, bill to monthly invoice
```

```
PRODUCT
  Name: Coolest Meeting Room
  Type: Bookable
  List Price: $10 per 10 mins
  Default term: Today to next year
  Products included:
```

Coolest Meeting Room

PROPOSAL
Customer or prospect: Customer A

Property: One World Trade

Product: Coolest Meeting Room (Bookable)

Market price: $8 per 10 mins
Term: Jun. 1, 2019 to Jun. 1, 2022

Product: Mailing Address (subscription)

Market price: $100 per month
Term: May 2, 2019 to Apr. 5, 2020

Property: 321 Main Street
Product: Nice Meeting Room (subscription)

Market price: $10 per 10 mins
Term: Apr. 4, 2020 to Mar. 5, 2025

CONTRACT

Permission active

Customer: Customer A

Property: One World Trade

Product: Coolest Meeting Room (Bookable)

Deal price: $8 per 10 mins
Term: Jun. 1, 2019 to Jun. 1, 2022

Product: Mailing Address (subscription)

Deal price: $100 per month
Term: May 2, 2019 to Apr. 5, 2020

Property: 321 Main Street
Product: Nice Meeting Room (subscription)

Deal price: $10 per 10 mins

Term: Apr. 4, 2020 to Mar. 5, 2025

FLOOR SPACE (subscription)

INVENTORY

Name: Second Floor
Property: One World Trade Center
Area: 400000
Capacity: 400
Ceiling height: 8 ft
Description: Really nice windows all around and also
a brand new kitchen, hooray!
Sign date:
Commencement date:
Rent commencement date:
Expiration date:
Move in date:
Lease term (in months):
Period 1

Term
Price

Period 2

Term
Price

STOCK

```
PERMISSION
  The right to access floor space [Roles]
RULES
  IF lease is signed, check billing
  IF lease is signed, send lease details
  IF lease is signed, email lease details
  IF lease is signed, create new security group
  IF lease is signed, activate tenant access
  workflow for main contact
  IF lease is signed, create tenant portal login
  for main contact
  IF lease is signed, void additional pending
  proposals
  IF today's date == rent commencement
  date, bill client
  IF lease ends, remove security group
```

```
PRODUCT
  Name: Second Floor
  Type: Subscription
  List Price: $50 per sqft
  Default term: 5 years
  Products included:
```

Second floor
Gym membership
Unlimited coffee plan
Weekly office snacks

PROPOSAL
Customer or prospect: Customer A

Property: One World Trade

Product: Coolest Meeting Room (Bookable)

Market price: $8 per 10 mins
Term: Jun. 1, 2019 to Jun. 1, 2022

Product: Second Floor (subscription)

Period 1

Market price: $40 per sqft
Term: Jan. 1, 2019 to Jan. 1, 2023

Period 2

Market price: $45 per sqft
Term: Jan. 1, 2023 to Jan. 1, 2025

Period 3

Market price: $50 per sqft
Term: Jan. 1, 2025 to Jan. 1, 2030

Property: 321 Main Street
Product: Nice Meeting Room (subscription)

Market price: $10 per 10 mins
Term: Apr. 4, 2020 to Mar. 5, 2025

CONTRACT

Permission active

Customer: Customer A

1. Property: One World Trade

Product: Coolest Meeting Room (Bookable)

Deal price: $8 per 10 mins
Term: Jun. 1, 2019 to Jun. 1, 2022

Product: Second Floor (subscription)

Period 1

Deal price: $40 per sqft
Term: Jan. 1, 2019 to Jan 1, 2023

Period 2

Deal price: $45 per sqft
Term: Jan. 1, 2023 to Jan. 1, 2025

Period 3

Deal price: $50 per sqft
Term: Jan. 1, 2025 to Jan. 1, 2030

2. Property: 321 Main Street

Product: Nice Meeting Room (subscription)

Deal price: $10 per 10 mins
Term: Apr. 4, 2020 to Mar. 5, 2025

TRAIL MIX (transaction)

INVENTORY

Name: Trail mix
Quantity: 80
Brand: Brand X.
Type: Nuts and berries
Description: Really delicious snack and healthy,
too!
Price:

STOCK
PERMISSIONS
Permission to purchase snacks (Role)
RULES

IF transaction is requested, check billing
[Billing System]
IF checks fail, send notification to tenant
[Notifications from Notification Servers]
IF checks fail, send notification to account manager
[Notifications from Notification Servers]
IF checks pass, confirm transaction
IF transaction is confirmed, send email confirmation
to tenant
IF transaction is confirmed, bill to monthly invoice

PRODUCT
Name: Snack pack
Type: Transaction
List Price: $2.50
Default term: Today to next year
Products included:

Trail mix
Popcorn bag

PROPOSAL
Customer or prospect: Customer A

Property: One World Trade

Product: Snack pack (Transaction)

Market price: $2.50
Term: Jun 1, 2019 to Jun. 1, 2022

Product: Second Floor (subscription)

Period 1

Market price: $40 per sqft
Term: Jan. 1, 2019 to Jan. 1, 2023

Period 2

Market price: $45 per sqft
Term: Jan. 1, 2023 to Jan. 1, 2025

Period 3

Market price: $50 per sqft
Term: Jan. 1, 2025 to Jan. 1, 2030

Property: 321 Main Street
Product: Nice Meeting Room (subscription)

Market price: $10 per 10 mins
Term: Apr. 4, 2020 to Mar. 5, 2025

CONTRACT

Permission active

Customer: Customer A

1. Property: One World Trade

Product: Snack pack (Transaction)

Deal price: $2.50
Term: Jun. 1, 2019 to Jun. 1, 2022

Product: Second Floor (subscription)

Period 1

Deal price: $40 per sqft
Term: Jan. 1, 2019 to Jan. 1, 2023

Period 2

Deal price: $45 per sqft
Term: Jan. 1, 2023 to Jan. 1, 2025

Period 3

Deal price: $50 per sqft
Term: Jan. 1, 2025 to Jan. 1, 2030

2. Property: 321 Main Street

Product: Nice Meeting Room (subscription)

Deal price: $10 per 10 mins
Term: Apr. 4, 2020 to Mar. 5, 2025

In an example implementation, a property resource stock object 500 contains the attributes obtained from one or more property resource inventory objects that have been processed and filtered based on the rights templates 400 stored in rights template store 101.

In some embodiments, the trained model 152 is updated by feeding it a new property resource stock object 500.

The trained model 152 is used together with a recommendation engine 154 to generate rights templates 400. In some embodiments, the rights templates 400 are customized to enable new uses (e.g., amenities) associated with the one or more (existing or new) property resources based on combinations of attributes of the (new or used) property resources. Additional attributes can be added, e.g., via an interface of the property resource rights management system 100, to existing rights templates 400 to create custom rights templates 400.

In an example implementation, input data is fed to trained model 152 as raw data for modeling and determining the rights template 400 attributes. This input data together with the recommendation engine 154 determine the label(s), rule(s), and workflow(s) and any linking between two or more rights templates 400.

In an example implementation, a churn modeling algorithm is fed labels from a property resource stock object 500 and, in turn, used with the recommendation engine 154 to generate label(s), rule(s) and workflow(s) of a rights template 400 and any linking between two or more rights templates 400. Churn modelling is used to predict the probability that a tenant will, for example, leave a space within a given time frame. Generally, a churn model is a binary classification model that given a set of predictors, or input variables, outputs a classification. For instance, a churn model can be used to predict the probability that tenant renting a unit will leave the unit within a given time frame, for example in one (1) year.

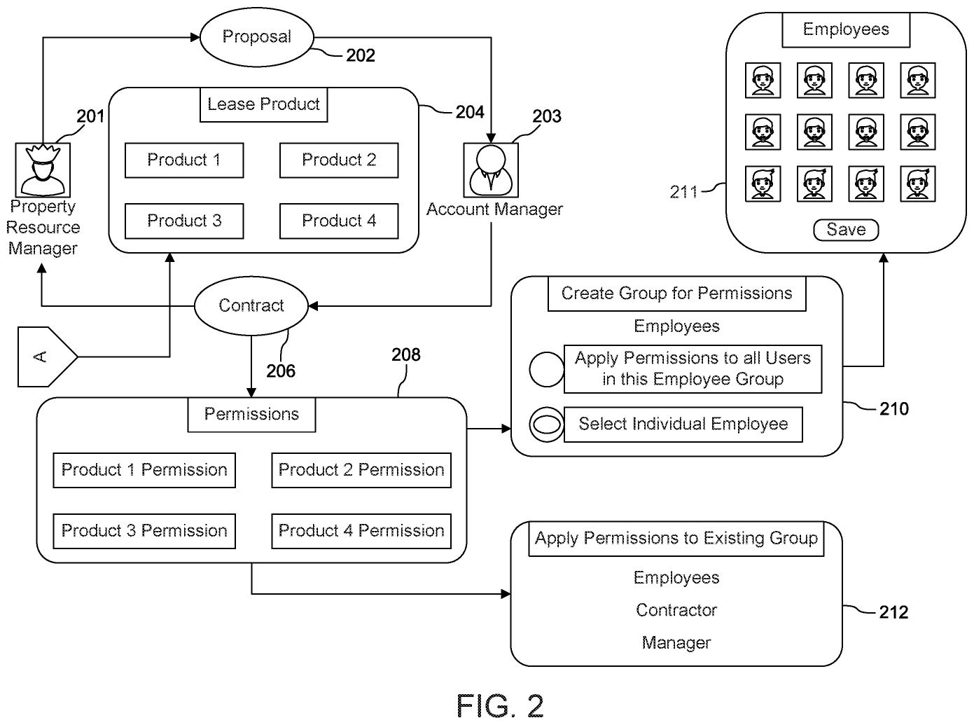

Armed with this knowledge, property resource rights management system 100 can better understand how a mixture of tenants will change over time and which units of a property are likely to soon become available. This enables a property resource manager 201 (FIG. 2) to proactively target the high churn candidates and provide incentives for them to extend their contract (e.g., by customizing rights templates 400 to provided more amenities using available property resources). In addition, the trained model 152 can highlight which units likely will need to be filled in the future, so that the vacancy period of a unit can reduced.

Churn models can also be used efficiently as a component of larger forecasting models, where the probability of churn is factored into future cash flow streams and aggregated across a broad population of tenants. By doing this, a real estate company can make more accurate predictions of its cash flow and therefor increase its total leverage without a proportional increase in risk. Ultimately, leading to a more efficient use of capital and property resources such as computing resources.

Rights templates 400 generated this way will not only encapsulate the attributes of a given property resource but also a characteristic and a workflow associated with the property resource. For example, in an example property occupancy optimization implementation, one or more real asset templates work in conjunction with other real asset templates and build a parent-child, child-child relationship on-demand or by recommendation building/generating a workflow which covers not only functionality of an atomic property resource but will fit in a rights template 400 as extended business rules, properties and attributes.

Every interaction that a property-related subsystem (e.g., building owner system, landlord system, occupant system, and building operator system) can have with a property resource is reduced to a predetermined set of rights embodied in a rights template 400. For example, with regard to a property resource, the predetermined set of rights can be categorized according to whether the property resource is a real asset, a service and/or a transaction. Real asset resource rights, service rights and transaction rights are associated with property resources 116 such as real asset resources 116a, services 116b and transactions 116c, correspondingly. Rights templates 400 thus contain digitized real asset resource rights, service rights and/or transaction rights in the form of data with corresponding rules and workflows, as well as an identification of the underlying property resource.

Referring still to FIG. 1, property resource rights management system 100 is a computer-implemented system that profiles property resources into property resource digital objects including property resource inventory objects, property resource rights objects and property resource stock objects 500. An instance of a property resource digital object is instantiated by, for example, defining a particular property resource digital object within a class, giving it a name, and storing it in a non-transitory memory. In turn, the property resource rights management system 100 uses the property resource digital object to monitor, select, retrieve, identify, and/or manage the possession, control, exclusion, enjoyment and disposition of the aspects of the applicable property resources.

As shown in FIG. 1, property resource rights management system 100 includes a rights template store 101, a property resource rights object builder 102 (also referred to as a rights builder 102), an inventory management application programming interface (API) 104, a create, read, update and delete (CRUD) inventory interface 106, a property resource inventory object database 108, a property resource rights object library 110 (also referred to as a rights library 110), a CRUD stock interface 112, and a property resource stock object database 114 (also referred to as stock database 114).

Rights template store 101 is fed the rights template 400 including attributes, rules and workflows associated with potential property resources 116, namely real asset resources 116a, services 116b and transactions 116c, the available rights for each, and how these rights are used together for particular real asset resources. Potential property resources 116 are categorized according to a predetermined number of asset types 116a. Services 116b are defined to fall within a predetermined number of service types 116b. Transactions 116c are defined to fall within a predetermined number of transaction types.

Property resource rights object builder 102 is configured to generate so-called “property resource rights objects”. A property resource rights object is a class defined as a template that describes the label(s) associated with the type of property resource, the rule(s) associated with the type of property resource, the workflow(s) associated with the type of property resource, and any linking between two or more rights templates 400. A property resource rights object is, in turn, used to generate property resource stock objects 500.

Property resource rights object library database 110 is configured to store the property resource rights objects generated by property resource rights object builder 102. Inventory management API 104 is communicatively coupled to CRUD inventory interface 106 and to property resource rights object builder 102 and configured to provide communication capabilities between the two entities.

CRUD inventory interface 106 is configured to enable a user to create, read, update and delete the property resource inventory objects that are contained in property resource inventory object database 108. In an example embodiment, CRUD inventory interface 106 is a graphical user interface presented to a user such as a system administer for a property owner. Inventory management API 104 obtains property resource inventory via CRUD inventory interface 106 after CRUD inventory interface 106 has been used to perform the create, read, update and delete operations on the property resource inventory objects received from property resource inventory object database 108.

The property resource rights object builder 102 is in communication with the property resource rights object library 110 and the inventory management API 104. In some embodiments, property rights object builder 102 combines the rights templates 400 and property resource inventory objects that have been processed by the CRUD inventory interface 106 to form property resource rights objects. In turn, property rights object builder 102 feeds the combination to rights object library 110.

Property resource rights object library 110 is configured to feed property resource rights objects to a CRUD stock interface 112. CRUD stock interface 112 is configured to provide an interface to enable a user to create, read, update and delete property resource rights objects retrieved from property resource rights object library 110. The result of the operations performed by the CRUD stock interface 112 is a property resource stock object 500. The output of the CRUD stock interface 112 is fed to a property resource stock object database 114 which is configured to store property resource stock objects 500.

### Object Definition and Workflows

Each property resource (e.g., real asset resource, service or transaction) follows an onboarding process. In some embodiments, a particular onboarding process is the same irrespective of whether the property resource is a real asset resource, service or transaction. In some embodiments, an onboarding process follows the following flow:

INVENTORY><<STOCKS>>>PRODUCTS>>>PROPOSAL>>>CONTRACT

Prior to onboarding, property resources (e.g., items/goods) and their respective attributes are stored in property resource inventory object database 108 in the form of property resource inventory objects as described above. As explained above, property resource inventory objects are sometimes referred to herein simply as inventory. In an example implementation, property resource inventory objects are in the form of fields and a data label describing the particular inventory. In some embodiments, at this point the inventory need not have rules or workflows associated with them.

As described above, property resource stock objects 500 are inventory that have been processed. Property resource stock objects 500 are also sometimes referred to simply as stocks. The result of the processing of the property resource inventory objects (inventory) are property resource stock objects 500 that include data with rules and workflows (stocks).

Products are stocks with list pricing/costing (individually and collectively referred to simply as “pricing”), market pricing or deal pricing along with term or duration if required. A product can also contain bookable, subscription, or transaction attributes, which defines and packages similar products into a category:
Bookable—a product can be booked for a finite duration (e.g., hours, days and weeks)
Subscription—a product can be subscribed for a finite or infinite duration. (e.g., weeks, years or decades)
Transaction—a transaction can be a one-off purchase of any product

A proposal is a product or group of products that is marked at market price along with a duration and sent to a client or a tenant.

A contract is a proposal that has been finalized and agreed upon between the applicable parties (e.g., landlord, asset manager and/or client/tenant) at a deal price with a duration.

FIG. 2 depicts architectural diagram illustrating flows according to an example aspect of the present invention. As described above, products are subsets property resource stock objects 500 stored in property resource stock object database 114 (FIG. 1). In some embodiments, products include additional contractual term information as illustrated with respect to some of the property resource stock objects 500 in TABLE 1 above. For example, products can be in the form of a property resource stock objects 500 including contractual terms. As illustrated in FIG. 2, a property resource (e.g., real asset) manager 201 issues a proposal 202 for one or more products 204 (e.g., lease products in FIG. 2). An account manager 203 receives the proposal and, if accepted, causes the property resource rights management system 100 to communicate the acceptance to the property resource manager 201. In turn, property resource manager 201 causes the property resource rights management system 100 to generate a contract 206. In some embodiments, the property resource rights management system 100 is configured to receive a counter-proposal from the account manager 203 and communicate the counter-proposal to the property resource manager 201.

As described above, rights are associated with the property resources (e.g., asset resource rights, service rights, transaction rights) and embodied as rights templates 400. Another aspect of the present invention involves enforcing the permissions based on the particular product. As shown in FIG. 2, product resource permissions 208 are assigned based on the particular product resource (e.g., Product 1, Product 2, Product, 3, Product 4, etc.).

A group is a collection of permissions (also referred to as a role) created to serve as a secondary function for controlling access to a product. As shown in block 210, a group for permissions is created. The collection of permissions (i.e., the defined group) can be applied to an individual user or one or more users. For example the collection of permissions can be applied to all users (Employee Group in block 210) or to an individual user (Individual Employee in block 210).

FIG. 2 also illustrates a permissions graphical user interface 211 that can be used to provide permissions to particular entities, such as employees. Permissions can also be provided to existing groups of entities as shown in block 212. Permissions define the granular access associated with a given stock (e.g., product).

A user can decide to use or not use a stock. In some embodiments, building a permission around a product or group of products requires a different workflow. As soon a contract is entered, all of the products (e.g., one or more products) within that contract will have individual rights which, in turn, will be picked by an individual tenant or the account manager 203 and assigned respective roles.

In some embodiments, rules associated with a stock are a set of explicit or understood regulations or principles governing conduct within a particular activity or sphere. For example, rules can be a set of instructions that are performed in case of any matching event occurring within a product workflow. The following are example rules:
IF transaction is requested, check billing
IF checks fail, send notification to tenant

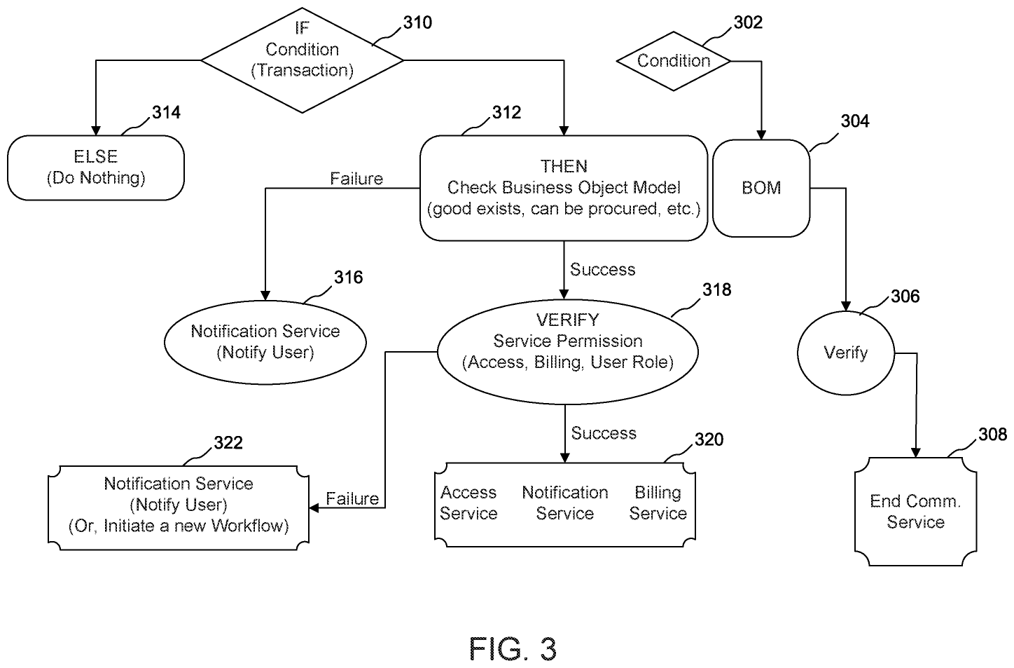

FIG. 3 is a process flow in accordance with an example embodiment of the present invention. Services according to aspects of the embodiments described herein include:
Condition Service 302. A condition service 302 is a service that performs a conditional statement (e.g., if-then-else) based on hypothesis and conclusion.
Business Object Model (BOM) Service 304. A business object model (BOM) service 304 is an object model describing the realization of business use cases. It serves as an abstraction of how business workers and business entities need to be related and how they collaborate to perform the business.
Verification Service 306. A verification service 306 is a service that verifies and validates according to the existing service or dataset.
End Communication Service 308. An end communication service 308 is a service that performs final/end service communications (e.g., access service, notification service, billing services). In some embodiments, such a communication is to a third party.

In some example implementations, the conditional and verification are not going to change. In some example implementations, the conditional and verification are going to change slightly. In some embodiments, only business object modeling service 304 and end communication service 308 are going to change. If a rules fails, end service communications will point to a notification service, which can perform an appropriate action, such as notify a user or initiate a new workflow). If the rules require, for example, a new tenant sign up, end communication service 308 will create a new account and email.

Blocks 310, 312 and 314 of FIG. 3 illustrate a conditional IF-THEN-ELSE conditional test associated with a transaction executed by the condition service 302. If a determination is made at step 310 that the condition has been met, then at step 312, the business object model service 304 performs a check to determine if a particular real asset (e.g., item, article or good) exists, whether it can be procured, and the like. If not, in this example implementation, nothing else is performed, as shown in step 314.

If at step 312, a failure occurs, e.g., a good does not exist or cannot be procured, then the end communication service 308 notifies the appropriate user and the process ends, as shown in step 316. If step 312 is a success, then verification service 306 performs a verification to verify the applicable service permission, as shown in step 318. If the verification at step 318 is successful, then at step 320 an end service communication is generated such as by an access service, a notification service, a billing service, or any combination of the forgoing. If the verification at step 318 fails, then the end service communication is performed by a notification service as shown in step 322. In some embodiments, the user is notified. In some embodiments a new workflow is initiated.

In some embodiments, rules can have a uniqueness pre-defined. For example in the case of access control, if access is already added to a property or a portfolio then it need not be added again.

In some embodiments a proposal or allocation are part of a products workflow and will not be visible/editable during rights builder creation. But still will be the part of individual rights template 400.

In another example implementation, an escalation of the price can be introduced to obtain an approval on the price. For example, if a broker enters a market price for a ‘Right’ that needs an approval process by the asset manager 201 (FIG. 2) before it becomes a deal price. Or the asset manager 201 can define rules against the pricing, dates and term so it automatically validates a broker input before finally initiating an escalation process.

The performance of the one or more actions described above enables enhanced and automated property resource management corresponding to the one or more property resources (e.g., real assets, services, transactions). This means that property resource management can be optimized and property resource rights can be generated for a digitized inventory item for use by various entities (e.g., a building owner, a landlord, an occupant, a building operator, and the like), according to the processes described herein and such property resource rights management and provisioning can be performed automatically and at significantly improved rates. For example, the throughput of property resource allocation is significantly enhanced. The property resources which are provisioned according to the processes described herein can thus be pre-emptively obtained, processed and stored locally within a computer, or transmitted to the computer, such that the property resources is immediately accessible and relevant to a user of the computer. In addition, the actions provide intelligent workflows which are adaptable based on data analytics obtained from various property resources.

The example embodiments described herein may be implemented using hardware, software or a combination thereof and may be implemented in one or more computer systems or other processing systems. However, the manipulations performed by these example embodiments were often referred to in terms, such as entering, which are commonly associated with mental operations performed by a human operator. No such capability of a human operator is necessary, in any of the operations described herein. Rather, the operations may be completely implemented with machine operations. Useful machines for performing the operation of the example embodiments presented herein include general purpose digital computers or similar devices.

From a hardware standpoint, a CPU typically includes one or more components, such as one or more microprocessors, for performing the arithmetic and/or logical operations required for program execution, and storage media, such as one or more memory cards (e.g., flash memory) for program and data storage, and a random access memory, for temporary data and program instruction storage. From a software standpoint, a CPU typically includes software resident on a storage media (e.g., a memory card), which, when executed, directs the CPU in performing transmission and reception functions. The CPU software may run on an operating system stored on the storage media, such as, for example, UNIX or Windows, iOS, Linux, and the like, and can adhere to various protocols such as the Ethernet, ATM, TCP/IP protocols and/or other connection or connectionless protocols. As is well known in the art, CPUs can run different operating systems, and can contain different types of software, each type devoted to a different function, such as handling and managing data/information from a particular source, or transforming data/information from one format into another format. It should thus be clear that the embodiments described herein are not to be construed as being limited for use with any particular type of server computer, and that any other suitable type of device for facilitating the exchange and storage of information may be employed instead.

A CPU may be a single CPU, or may include plural separate CPUs, wherein each is dedicated to a separate application, such as, for example, a data application. Software embodiments of the example embodiments presented herein may be provided as a computer program product, or software, that may include an article of manufacture on a machine accessible or non-transitory computer-readable medium (i.e., also referred to as “machine readable medium”) having instructions. The instructions on the machine accessible or machine readable medium may be used to program a computer system or other electronic device. The machine-readable medium may include, but is not limited to magneto-optical disks or other type of media/machine-readable medium suitable for storing or transmitting electronic instructions. The techniques described herein are not limited to any particular software configuration. They may find applicability in any computing or processing environment. The terms “machine accessible medium”, “machine readable medium” and “computer-readable medium” used herein shall include any non-transitory medium that is capable of storing, encoding, or transmitting a sequence of instructions for execution by the machine (e.g., a CPU or other type of processing device) and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

In addition, not all of the components are required to practice the invention, and variations in the arrangement and type of the components may be made without departing from the spirit or scope of the invention. As used herein, the term “component” is applied to describe a specific structure for performing specific associated functions, such as a special purpose computer as programmed to perform algorithms (e.g., processes) disclosed herein. The component can take any of a variety of structural forms, including: instructions executable to perform algorithms to achieve a desired result, one or more processors (e.g., virtual or physical processors) executing instructions to perform algorithms to achieve a desired result, or one or more devices operating to perform algorithms to achieve a desired result.

While various example embodiments have been described above, it should be understood that they have been presented by way of example, and not limitation. It will be apparent to persons skilled in the relevant art(s) that various changes in form and detail can be made therein. Thus, the present invention should not be limited by any of the above described example embodiments, but should be defined only in accordance with the following claims and their equivalents.

1. A computer-facilitated method for optimizing management of property resource rights, the method comprising:
digitizing a property resource having a type and at least one attribute, thereby generating a property resource inventory object; and
generating a property resource rights object for the property resource based on the property resource inventory object and a rights template.

2. The method according to claim 1, further comprising:
generating a rights template based on a mapping one or more labels associated with the type of property resource, one or more rules associated with the type of property resource, one or more workflows associated with the type of property resource, and one or more linkings between two or more rights templates.

3. The method according to claim 1, wherein the property resource is a real asset resource, a service or a transaction.

4. The method according to claim 1, further comprising:
training a model based on property resource usage data according to a machine learning algorithm, thereby generating a trained model;
generating a rights template based using the trained model; and
storing, in a rights template store, the rights template.

5. The method according to claim 1, wherein the rights template contains one or more attributes associated with the type of property resource, one or more rules associated with the type of property resource, one or more workflows associated with the type of property resource, and at least one linking between two or more rights templates

6. The method according to claim 1, further comprising:
generating a property resource stock object by applying the rights template to the property resource inventory object.

7. The method according to claim 6, wherein the property resource stock object contains one or more labels associated with type of property resource, one or more rules associated with type of property resource, one or more workflows associated with type of property resource, at least one linking between two or more rights templates, and one or more attributes from the property resource inventory object.

8. A system for optimizing property resource rights management, comprising:
one or more processors and one or more storage devices storing instructions that are operable, when executed by the one or more processors, to cause the one or more processors to:
digitize a property resource having a type and at least one attribute, thereby generating a property resource inventory object; and
generate a property resource rights object for the property resource based on the property resource inventory object and a rights template.

9. The system according to claim 8, the one or more processors further operable to:
generate a rights template based on a mapping one or more labels associated with the type of property resource, one or more rules associated with the type of property resource, one or more workflows associated with the type of property resource, and one or more linkings between two or more rights templates.

10. The system according to claim 8, wherein the property resource is a real asset resource, a service or a transaction.

11. The system according to claim 8, the one or more processors further operable to:
train a model based on property resource usage data according to a machine learning algorithm, thereby generating a trained model;
generate a rights template based using the trained model; and
store, in a rights template store, the rights template.

12. The system according to claim 8, wherein the rights template contains one or more attributes associated with the type of property resource, one or more rules associated with the type of property resource, one or more workflows associated with the type of property resource, and at least one linking between two or more rights templates

13. The system according to claim 8, the one or more processors further operable to:
generate a property resource stock object by applying the rights template to the property resource inventory object.

14. The system according to claim 13, wherein the property resource stock object contains one or more labels associated with type of property resource, one or more rules associated with type of property resource, one or more workflows associated with type of property resource, at least one linking between two or more rights templates, and one or more attributes from the property resource inventory object.

15. A non-transitory computer-readable medium having stored thereon one or more sequences of instructions for causing one or more processors to perform the methods according to any one of claims 1 to 7.
